(19) United States
(12) Patent Application Publication
(10) Pub. No.: US 2010/0257031 A1
(43) Pub. Date: Oct. 7, 2010

(54) INTERACTIVE ADVERTISING SYSTEM AND METHOD THEREOF

(76) Inventor: Li-Hsiang Chao, Irvine, CA (US)

Correspondence Address: SCHMEISER, OLSEN & WATTS, 22 CENTURY HILL DRIVE, SUITE 302, LATHAM, NY, 12110, US

(21) Appl. No.: 12/417,710

(22) Filed: Apr. 3, 2009

(51) Int. Cl. G06Q 30/00

(52) U.S. Cl. 705/14.1; 705/14.39

(57) ABSTRACT

In an interactive advertising system and a method thereof, the system includes: an advertising platform system, for storing at least one advertising and a specific answer related to the advertising content provided by at least one advertiser; and at least one man-machine interface, for connecting the advertising platform system through a network. If the advertising platform system provides at least one reply screen to the man-machine interface through the network, and a user give at least one answer to at least one reply screen, the advertising platform system will compare the answer with the specific answer and rebate a predetermined amount of bonus to the user according to a comparison result. Therefore, the user can get a bonus after browsing the advertising and answering the question, such that the key points of the advertising can further give a deeper impression to users to improve the exposure and advertising effects.

### FIELD OF THE INVENTION

The present invention relates to an advertising system, in particular to an interactive advertising system and an interactive advertising method capable of improving the advertising effect.

### BACKGROUND OF THE INVENTION

At present, internet advertising is generally divided into static advertising, sign-board advertising, interstitials, and rotating advertising, but people generally pay no attention or unmindfully view the aforementioned advertising, and thus most of them achieve a poor advertising effect.

In general, a website platform provides all kinds of information and advertising and expects net surfers to spend money on the purchase of products provided by the advertisers, but the advertisers usually do not give a bonus or rebate to the net surfers. Even if a website using an e-mail for conducting a marketing survey and rewarding interviewees by a bonus raises a question such as “Will you go to a doctor or take a medicine for a cold?” and gives a bonus to the net surfer who answers the question that is not related to the advertising at all or obtains a bonus by clicking the advertising, the net surfers still pay no particular attention to the advertising content, but simply hurry to click the next advertising in order to get more bonuses.

Further, mobile phone messages are used for giving out or answering a predictive question such as “How many gold medals can the United States get in the Beijing 2008 Olympic Gaines?” The prize is “A lucky draw for . . . ”, but not “Everyone can get a prize”. The question and the answer have no relation with the advertising itself, and the effect of a quick advertising cannot be achieved.

Thus, the present invention can improve the Internet advertising exposure and advertising effect over the prior art.

### SUMMARY OF THE INVENTION

Therefore, it is a primary objective of the present invention to provide an interactive advertising system and an interactive advertising method to improve the advertising effect over the prior art.

The interactive advertising system of the invention comprises: an advertising platform system, including at least one advertising and a specific answer related to an advertising content provided by at least one advertiser; and at least one man-machine interface, for connecting the advertising platform system through a network, wherein the advertising platform system provides at least one reply screen to the man-machine interface through the network, such that after a user enters at least one answer from at least one reply screen, the advertising platform system will compare the answer with at least one specific answer, and rebate a predetermined amount of bonus to the user according to a comparison result.

The present invention also discloses an interactive advertising method comprising the steps of: storing at least one advertising and a specific answer related to the content of the advertising provided by at least one advertiser into an advertising platform system; providing at least one reply screen to a user through a network for giving at least one answer at the reply screen; comparing the answer with at least one specific answer; and rebating a predetermined amount of bonus to the user according to a comparison result.

### BRIEF DESCRIPTION OF THE DRAWINGS

FIG. 1 is a schematic system block diagram of the present invention;

FIG. 2 is a flow chart of a logon procedure of the present invention;

FIG. 3 is a flow chart of a first preferred embodiment of the present invention;

FIG. 4 is a flow chart of a second preferred embodiment of the present invention; and

FIG. 5 is a flow chart of a third preferred embodiment of the present invention.

### DESCRIPTION OF THE PREFERRED EMBODIMENTS

Other features and advantages of the present invention will become apparent in the following detailed description of the preferred embodiment with reference to the accompanying drawings.

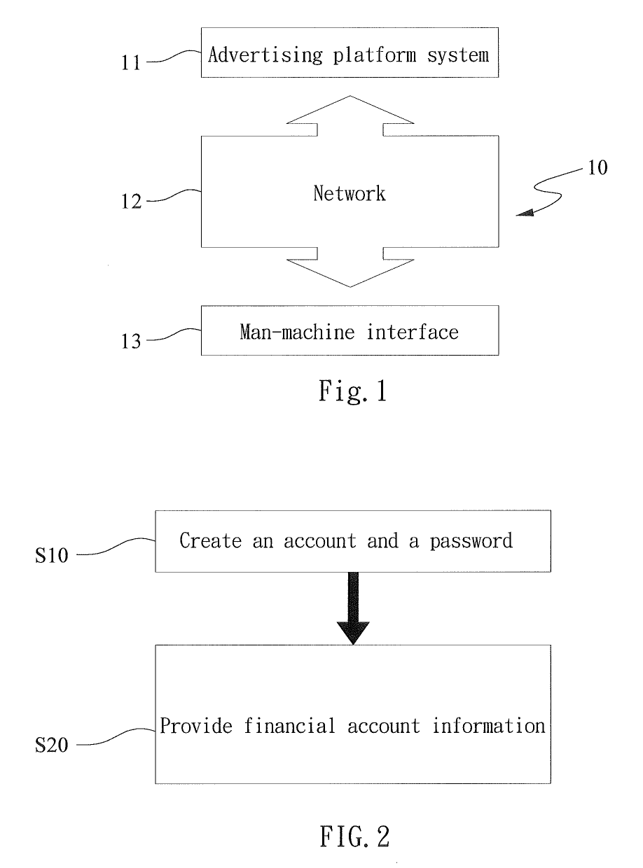

With reference to FIG. 1 for a schematic system block diagram of the present invention, the present invention discloses an interactive advertising system and an interactive advertising method, wherein the interactive advertising system 10 comprises: an advertising platform system 11, at least one advertising and at least one question related to the advertising content provided by at least one advertiser; and at least one man-machine interface 13, for connecting the advertising platform system 11 through a network 12, wherein the advertising platform system 11 provides the advertising and the question related to the advertising content to the man-machine interface through the network 12, such that after a user has answered the question, the advertising platform system 11 rebates a predetermined amount of bonus to the user.

The advertising platform system 11 stores at least one advertising and at least one question related to the advertising content provided by at least one advertiser. The advertising platform system 11 provided by an advertising platform provider has a function similar to an entry or a shopping website (or webpage) provided for users to browse the Internet. After paying a fee of a specific amount to the advertising platform provider, the advertiser can store the advertising and the question related to the advertising content to the advertising platform system 11 for the users to answer the question online. In addition, the advertising and the question related to the advertising content stored in the advertising platform system 11 can be sent to users through an email or a telecommunication network message and provided for users to browse the advertising and answer the questions. For example, if the advertiser is a food manufacturer (with a brand A), and provides a food advertising related to the brand A and at least one related question to the advertising platform provider, and stores the related food advertising and the question(s) into the advertising platform system 11, the users will be able to browse the information online or the information will be sent to users actively through the email or the telecommunication network message. The advertising of the brand A usually focuses on features such as food certification, celebrity advertising, and special ingredient, etc, and thus the advertisers can set at least one question related to the advertising content according to the features of their products or services. For example, the questions with an easy answer are “Whether or not the food of brand A is certified?”, “Who is the celebrity doing the food advertising for brand A?” and “What are the special ingredients?” The questions are intended for letting users understand the key points of the advertising and give correct answers to give a deeper advertising impression.

At least one man-machine interface 13 of the interactive advertising system 10 of the invention is connected to the advertising platform system 11 through the Internet 12 or the telecommunication network, such that the users can browse the advertising provided by the advertiser and answer the questions related to the advertising content or the advertising platform system 11 actively sends the advertising and the questions related to the advertising content to the user through an email or a telecommunication network message for the user to browse the advertising and answer the question. If a user connects to the advertising platform system 11 by the man-machine interface 13 via the Internet and gives a correct answer to the question related to the advertising content, or the advertising platform system 11 actively sends a question to the user through an email or a telecommunication network message and the user gives a correct answer, the advertising platform system 11 will rebate a predetermined amount of bonus to the user according to the number of correctly answered questions. For example, if an advertiser sets three levels of questions related to the advertising content, then the advertising platform system 11 will rebate a user with a bonus according to the number of the correctly answered questions. For two correct answers, $1 is rebated for each answer, so that the user can obtain a total of $2 for the cash rebate in this case, and the bonus is rebated according to the number of correctly answered questions. Of course, the system can design three levels of questions and give a bonus to the user only if the user answers all of the three questions correctly.

The questions related to the advertising content and their answers can be designed in multiple-choice questions or a pull-down menu is provided for users to click the answers.

The rebated bonus can be a cash rebate, a bonus point, a bonus gift, a discount bonus, a gift certificate bonus, or any other bonus (hereinafter referred to as a “bonus”).

Since the advertising platform system 11 of the invention will rebate a bonus to users, therefore the advertising platform system 11 has to confirm the user's identity. If the advertising platform system 11 actively sends the advertising and the questions to users through an email, then the questions should include a field provided for the users to fill in their personal data and confirm their identity. If the advertising platform system 11 actively sends the advertising and the questions to a user through a telecommunication network and the user gives an answer through a mobile phone, then the telecommunication company will be able to confirm the user's identity though the mobile phone number and inform the advertiser about the confirmation of the user's identity. If the user connects to the advertising platform system 11, the user can also browse the webpage (or website) of the advertising platform system 11 and view the advertising to answer the questions. The user should complete a logon step as shown in FIG. 2, wherein the user creates an account and a password (S10) for facilitating the advertising platform system 11 to record the rebated bonus into the user's account. If the rebated bonus is in terms of cash, then the user should provide financial account information (S20) to facilitate a remittance. Therefore, the user simply needs to enter the account and the password to connect the advertising platform system 11, and the advertising platform system 11 will confirm the user's identity and financial account information.

With the incentive of the bonus, the user will view the advertising carefully. If there is another bonus awarded to users who recommend the advertiser's product or service to their friends and relatives, then the advertising activity will be spread out extensively, and many people will visit the advertiser's website to browse the advertising and answer the questions. As a result, the exposure will increase the awareness of the advertising platform system 11 (generally referred to the advertiser's webpage or website), and the users will have a deeper advertising impression.

If the rule of the game requires a user to view the advertising question, answer all questions correctly, and use all (or a portion of) the awarded bonuses to purchase any of the advertiser's products or services, the advertisers will be more willing to put up their advertising. Regardless of various different names of the bonuses, the bonuses are operated in terms of cash, and thus creating a triple-win situation for the advertisers, the platform providers and the users.

Users may answer the same question repeatedly in order to obtain more bonuses from a specific advertising, and thus the advertising platform system 11 will record the answered questions according to the user account and the password to prevent a user from answering the same question again within a unit time or give no rebate or bonus again within a unit time, or the system will be designed in such a way that if a user logs on the advertising platform system 11, the advertising platform system 11 will lock on a certain customer group to actively provide the advertising and the related questions to the users of the customer group to avoid a waste of costs.

The questions provided by the advertisers and the answers provided by the users are not limited to a textual form, but the media for the questions and answers of the present invention can be in a form of symbols, sounds, colors, shapes, sizes and games. For example, an advertiser provides similar screens and allows users to find the differences between similar screens, and the advertiser expects to give a deeper impression on the differences to the users.

In the present invention, the man-machine interface 13 can be a computer, a mobile phone, or any electronic device connected to the advertising platform system 11 via the Internet.

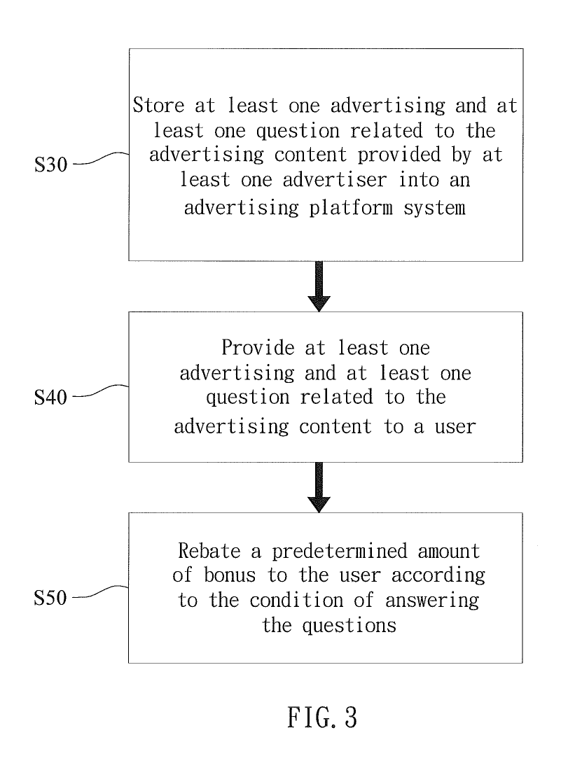

With reference to FIG. 3 for a flow chart of a first preferred embodiment of the present invention, the Internet interactive advertising method of the invention comprises the steps of: storing at least one advertising and at least one question related to the advertising content provided by at least one advertiser into an advertising platform system (S30), wherein the advertising platform system is provided by an advertising platform provider for providing a function similar to an entry or a shopping website (or webpage), such that users can browse the website. After the advertiser has paid a specific fee to the advertising platform provider, the advertiser can store the advertising and the questions related to the advertising content into the advertising platform system, so that the advertising platform system can provide the advertising and the questions related to the advertising content to the user (S40) when the user logs on the advertising platform system. The advertising platform system locks on a certain customer group to randomly and actively provide the advertising, or the advertising platform system provides the corresponding advertising questions after the user clicks a desired advertising. The advertising platform system 11 actively sends the advertising and the related questions to a user through an email or a telecommunication network message, so that the user can browse the advertising and answer the questions related to the advertising content. After the user has answered the preset questions, the advertising platform system rebates a predetermined amount of bonus to the user according to the condition of answering the questions (S50).

As described above, the condition of answering questions refers to the number of questions answered correctly by the user, or a condition for the advertising platform system to give a corresponding bonus to the user when all set questions are answered correctly by the user.

In general, advertising comes with a slogan, a catch phrase or promotion information, such as “McDonald's®—I'm lovin' it”, “Walmart®—Save money. Live better” or a film developing company's promotion on “4×6 photo for $X only”. If these advertising slogans, catch phrases, or promotion information are inputted by the users, a deeper advertising impression will be given to the users.

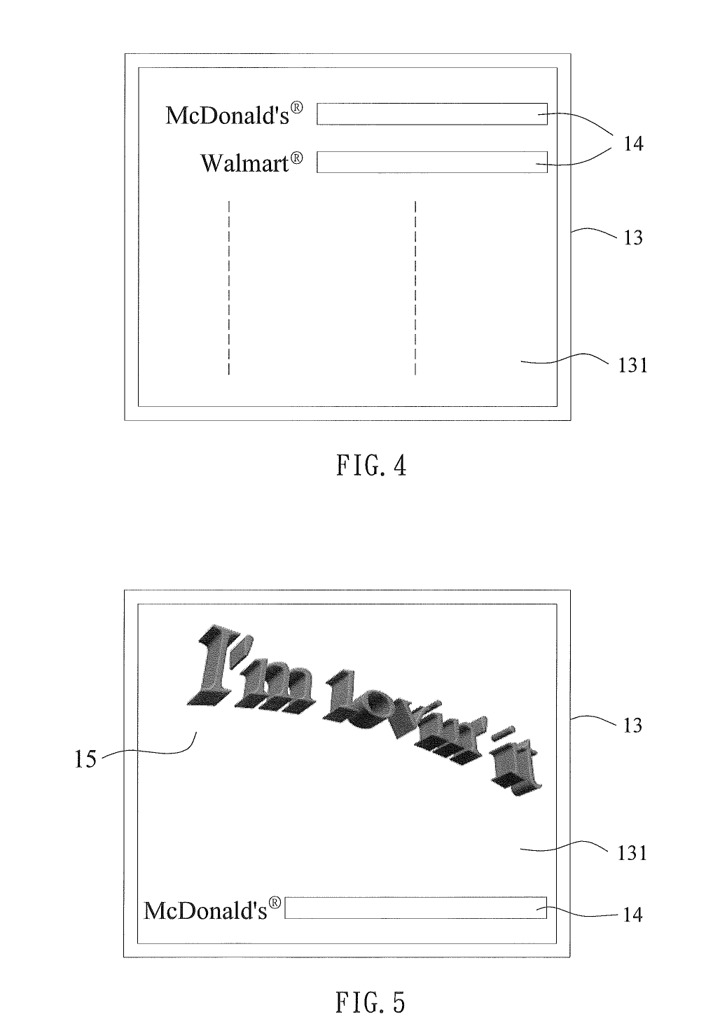

With reference to FIG. 4 for a flow chart of a second preferred embodiment of the present invention together with FIG. 1, the advertising platform system 11 of the invention stores at least one advertising and a specific answer (which is an advertising slogan, a catch phrase or promotion information) related to the advertising content provided by at least one advertiser. The advertising platform system 11 provided by an advertising platform provider has a function similar to an entry or a shopping website (webpage) provided for users to browse information via the Internet. After paying a specific fee to the advertising platform provider, the advertiser can store the advertising and the questions related to the advertising content into the advertising platform system 11 and provided for users to browse online. If a user connects to the advertising platform system 11 through the network 12 by using a man-machine interface 13, the advertising platform system 11 will provide at least one reply screen (including a plurality of input fields 14) to a display screen 131 of the man-machine interface 13 through the network 12, and the user has inputted at least one answer into at least one reply screen (including a plurality of input fields 14), the advertising platform system 11 will compare the answer with the specific answer, and will rebate a predetermined amount of bonus to the user according to a comparison result. For those who answer all questions correctly, a 100% of the predetermined amount of bonus is rebated. For those who answer the questions incorrectly, none or a portion (such as 50%) of the predetermined amount of bonus will be rebated, and the amount of bonus can be adjusted by the advertiser or the advertising platform provider as needed. For example, the original price for developing a photo is $2, and the advertiser will give a discount bonus for the film development. If a consumer browses 8 pieces of advertising and answers the questions correctly or inputs the advertising slogan, the catch phrase or the product promotion information, a 40% discount will be given for the film development. This arrangement attracts consumers to browse more advertising slogans, catch phrases or product promotion information to give a deeper advertising impression to consumers.

With reference to FIG. 5 for a flow chart of a third preferred embodiment of the present invention together with FIG. 1, the advertising platform system 11 of the invention stores at least one advertising and a specific answer (which is an advertising slogan, a catch phrase or product promotion information) related to the advertising content provided by at least one advertiser. If a user connects to the advertising platform system 11 through the network 12 by using a man-machine interface 13, the advertising platform system 11 will provide at least one advertising 15 and at least one reply screen (including a plurality of input fields 14) to the display screen 131 of the man-machine interface 13 through the network 12, and the user inputs at least one answer to at least one reply screen (including a plurality of input fields 14) according to the content of the advertising 15, the advertising platform system 11 will compare the answer with the specific answer and give a predetermined amount of bonus to the user according to a comparison result.

While the invention has been described by means of specific embodiments, numerous modifications and variations could be made thereto by those skilled in the art without departing from the scope and spirit of the invention set forth in the claims.

What is claimed is:

1. An interactive advertising system, comprising:
an advertising platform system, having at least one advertising and a specific answer related to an advertising content provided by at least one advertiser and stored in the advertising platform; and
at least one man-machine interface, connected to the advertising platform system through a network;
wherein the advertising platform system provides at least one reply screen to the man-machine interface through the network, such that after a user has entered at least one answer from at least one reply screen, the advertising platform system will compare the answer with the specific answer and rebate a predetermined amount of bonus to the user according to a comparison result.

2. The interactive advertising system of claim 1, wherein the user must go through a logon procedure after the user has connected the advertising platform system by the man-machine interface through the Internet.

3. The interactive advertising system of claim 2, wherein the logon procedure comprises the steps of creating an account and a password, and providing financial account information.

4. The interactive advertising system of claim 1, wherein the advertising platform system sends at least one reply screen through an email, and the reply screen is provided for the user to browse the advertising and answer the question.

5. The interactive advertising system of claim 3, wherein the advertising platform system records an answered question according to the account and the password, and will not give another rebate to the same question within a unit time.

6. The interactive advertising system of claim 1, wherein the advertising platform system randomly provides at least one reply screen when the user logs on the advertising platform system.

7. The interactive advertising system of claim 1, wherein the advertising platform system actively sends at least one reply screen to the user through a telecommunication network and provides the reply screen for the user to browse the advertising and answer the question.

8. The interactive advertising system of claim 1, wherein at least one reply screen includes a plurality of input fields.

9. The interactive advertising system of claim 8, wherein the user inputs at least one answer into each input field.

10. The interactive advertising system of claim 1, wherein at least one advertising is displayed in at least one reply screen.

11. The interactive advertising system of claim 1, wherein at least one answer is given by the user by clicking the answer in a pull down menu.

12. The interactive advertising system of claim 1, wherein at least one answer is given by the user by selecting the answer from a multiple of choices.

13. An interactive advertising method, comprising the steps of:
storing at least one advertising and a specific answer related to the advertising content provided by at least one advertiser into an advertising platform system;
providing at least one reply screen to a user through a network;
replying at least one answer in at least one reply screen;
comparing the answer with the specific answer; and
rebating a predetermined amount of bonus to the user according to a comparison result.

14. The interactive advertising method of claim 13, further comprising a logon procedure after the user connects the man-machine interface with the advertising platform system through the Internet.

15. The interactive advertising method of claim 14, further comprising the steps of creating an account and a password and providing financial account information.

16. The interactive advertising method of claim 15, further comprising a step of recording an answered question according to the account and the password by the advertising platform system, and giving no further rebate to the same question within a unit time.

17. The interactive advertising method of claim 13, wherein at least one reply screen includes a plurality of input fields.

18. The interactive advertising method of claim 17, wherein the user inputs at least one answer into each input field.

19. The interactive advertising method of claim 13, wherein at least one answer is given by the user by clicking the answer in a pull down menu.

20. The interactive advertising method of claim 1, wherein at least one answer is given by the user by selecting the answer from a multiple of choices.
